(19) United States
(12) Patent Application Publication
(10) Pub. No.: US 2026/0260643 A1
(43) Pub. Date: Sep. 3, 2026

(54) METHOD FOR REAL-TIME ADAPTIVE ACTIVE NOISE CONTROL, AND ADAPTIVE ACTIVE NOISE CONTROL EARPHONES

(71) Applicant: Bestechnic (Shanghai) Co., Ltd., Shanghai (CN)

(72) Inventor: Zikai WEI, Shanghai (CN)

(73) Assignee: Bestechnic (Shanghai) Co., Ltd., Shanghai (CN)

(21) Appl. No.: 19/433,496

(22) Filed: Dec. 26, 2025

Related U.S. Application Data
(63) Continuation of application No. PCT/CN2025/131217, filed on Oct. 30, 2025.

(30) Foreign Application Priority Data
Feb. 28, 2025 (CN) 202510233426.X

(51) Int. Cl. G10K 11/178

(52) U.S. Cl. CPC G10K 11/17817; G10K 11/17815; G10K 11/17823; G10K 11/17825; G10K 11/17881; G10K 2210/1081; G10K 2210/3026; G10K 2210/3027; G10K 2210/3028; G10K 2210/3055

(57) ABSTRACT

A real-time adaptive active noise cancellation method, an earphone, and a non-transitory computer-readable medium are provided. The method includes: obtaining a first transfer function from a feedforward microphone to a feedback microphone while ANC is deactivated; deriving a second transfer function from a speaker to the feedback microphone using the first transfer function while ANC is active; determining a current wearing state of the earphone based on a characteristic value from the second transfer function; and updating filter parameters based on the current wearing state. This includes adapting parameters of an IIR filter and subsequently updating parameters of an FIR filter using the adapted IIR parameters, the first transfer function, the second transfer function, and signals from the feedforward microphone.

### CROSS-REFERENCE TO RELATED APPLICATIONS

This application is a continuation of International Application No. PCT/CN2025/131217, filed on Oct. 30, 2025, which claims the benefit of priority to Chinese Application No. 202510233426.X, filed on Feb. 28, 2025, both of which are incorporated herein by reference in their entireties.

### TECHNICAL FIELD

The present application relates to the field of headphone technology, and in particular, to a real-time adaptive active noise control method and adaptive active noise control earphones.

### BACKGROUND

Active Noise Control (ANC) is a technology used to suppress environmental noise. It typically uses a prompt tone to select parameters for a filter, employs sensors (usually microphones) to collect noise signals and prompt tone signals, and utilizes a control algorithm to generate an anti-phase sound wave that counteracts the noise. This anti-phase wave is superimposed onto the audio signal to cancel out environmental noise, thereby achieving suppression or elimination of external noise.

However, since the parameters of the filter are usually limited to a fixed set of groups, they cannot achieve the optimal noise cancellation effect for different wearing positions. Moreover, existing methods only run once when the earphones are first worn and active noise cancellation is activated to determine the current wearing state and select the corresponding parameters for the filter. If the wearing position of the earphones is adjusted afterward, the parameters of the filter cannot be updated in real time, leading to a degradation in noise cancellation performance.

### SUMMARY

In view of the aforementioned technical problems existing in the related art, the present application is provided. The present application aims to provide a method for real-time adaptive active noise control and adaptive active noise control earphones.

According to a first aspect of the present application, a method for real-time adaptive active noise cancellation is provided, for use in active noise cancellation earphones. The earphones includes a feedforward microphone, a feedback microphone, a speaker, and a filter, where the filter includes an Infinite Impulse Response (IIR) filter and a Finite Impulse Response (FIR) filter. The method includes:

While the active noise cancellation is turned off, obtaining a first transfer function from the feedforward channel to the feedback channel based on signals collected by the feedforward microphone and the feedback microphone.

While the active noise cancellation is activated, obtaining a second transfer function from the speaker to the feedback channel based on the first transfer function and signals collected by the speaker.

Deriving a characteristic value based on the second transfer function to determine the current wearing state of the earphones based on the characteristic value, and updating parameters of the IIR filter according to the wearing state.

Obtaining updated first parameters for the IIR filter on the feedforward channel and updated second parameters for the IIR filter on the feedback channel; and updating parameters of the FIR filter based on the signals collected by the feedforward microphone, the first transfer function, the first parameters, the second parameters, and the second transfer function.

According to a second aspect of the present application, adaptive active noise cancellation earphones are provided, including a processor, a feedforward microphone, a feedback microphone, a speaker, and a filter, where the filter includes an IIR filter and an FIR filter. The processor is configured to:

While the active noise cancellation is turned off, obtain a first transfer function from the feedforward channel to the feedback channel based on signals collected by the feedforward microphone and the feedback microphone.

While the active noise cancellation is activated, obtain a second transfer function from the speaker to the feedback channel based on the first transfer function and signals collected by the speaker.

Derive a characteristic value based on the second transfer function to determine the current wearing state of the earphones based on the characteristic value, and update parameters of the IIR filter according to the wearing state.

Obtain updated first parameters for the IIR filter on the feedforward channel and updated second parameters for the IIR filter on the feedback channel; and update parameters of the FIR filter based on the signals collected by the feedforward microphone, the first transfer function, the first parameters, the second parameters, and the second transfer function.

According to a third aspect of the present application, a computer-readable storage medium is provided. The computer-readable storage medium stores computer instructions for causing a computer to execute the real-time adaptive active noise cancellation method described in various implementations of the present application.

According to a fourth aspect of the present application, a computer program product is provided, including computer instructions for causing a computer to execute the real-time adaptive active noise cancellation method described in various implementations of the present application.

The method provided by the implementations of the present application obtains the first transfer function from the feedforward channel to the feedback channel based on signals collected by the feedforward and feedback microphones when ANC is off. When ANC is activated, it obtains the second transfer function from the speaker to the feedback channel based on the first transfer function and signals from the speaker. It then derives a characteristic value from the second transfer function to determine the current wearing state and updates the IIR filter parameters accordingly. Furthermore, based on the updated IIR filter parameters, it optimizes the FIR filter parameters by updating them using the signals from the feedforward microphone, the first transfer function, the first parameters (updated feedforward IIR), the second parameters (updated feedback IIR), and the second transfer function. Thus, by continuously monitoring data changes from the feedforward microphone, feedback microphone, and speaker, the parameters of both the IIR and FIR filters can be updated in real-time. Any positional adjustment of the earphones during wear can trigger real-time adjustments of the ANC state, ensuring consistently effective noise cancellation throughout the wearing period.

The foregoing description is merely an overview of the technical solutions of the present application. To understand the technical means of the present application, it can be implemented according to the content of the description. Furthermore, to make the above-described and other objectives, features, and advantages of the present application more apparent and easier to understand, specific implementations of the present application are provided below.

### BRIEF DESCRIPTION OF THE DRAWINGS

The accompanying drawings, which are incorporated herein and form a part of the specification, illustrate aspects of the present disclosure and, together with the description, further serve to explain the principles of the present disclosure and to enable a person skilled in the pertinent art to make and use the present disclosure.

FIG. 1 shows a schematic diagram of the active noise cancellation structure of active noise cancellation headphones according to some implementations of the present application.

FIG. 2 shows a schematic flowchart diagram of a method for real-time adaptive active noise cancellation according to some implementations of the present application.

FIG. 3 shows a schematic flowchart diagram of a process for real-time updating of the ANC state according to some implementations of the present application.

The present disclosure will be described with reference to the accompanying drawings.

### DETAILED DESCRIPTION

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present disclosure.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In the present application, the arrows indicating the various steps in the diagrams are merely illustrative of the execution sequence and are not intended to be limiting. The technical solutions of the present application are not limited to the execution sequence described in the implementations. The steps in the execution sequence may be combined, split, or reordered, provided that the logical relationship of the execution content remains unaffected.

All terms (including technical and scientific terms) used in this application shall have the same or similar meanings as commonly understood by a person of ordinary skill in the art to which this application belongs, unless otherwise specifically defined. It should also be understood that terms defined in commonly used dictionaries should be interpreted as having meanings consistent with their meanings in the context of the relevant technology and should not be interpreted in an idealized or overly formal sense unless expressly so defined herein. Technologies and equipment known to persons of ordinary skill in the relevant art may not be discussed in detail but are to be considered part of the specification where appropriate.

Specific implementations of the present application are described hereafter with reference to the drawings; however, it is to be understood that the disclosed implementations are merely examples of the application, which may be embodied in various forms. Well-known and/or repetitive functions and constructions are not described in detail to avoid obscuring the application with unnecessary or redundant details. Consequently, specific structural and functional details disclosed herein are not to be interpreted as limiting, but merely as implementations or examples for the claims and as a representative basis for teaching one skilled in the art to variously employ the present application in any appropriately detailed structure.

The description may use the phrases “in one embodiment,” “in another embodiment,” “in yet another embodiment,” “in other embodiments,” “in one implementations,” “in some implementations,” “in one example,” or “in some examples” which may each refer to one or more of the same or different implementations in accordance with the present application.

Active Noise Control (ANC) is a technology used to suppress environmental noise. It typically uses a prompt tone to select parameters for an adaptive Infinite Impulse Response (IIR) filter, employs sensors (usually microphones) to collect noise signals and prompt tone signals, and utilizes a control algorithm to generate an anti-phase sound wave that counteracts the noise. This anti-phase wave is superimposed onto the audio signal to cancel out environmental noise, thereby achieving suppression or elimination of external noise.

However, since the parameters of the adaptive IIR filter are limited to a fixed set of groups, they cannot achieve the optimal noise cancellation effect for different wearing positions. Moreover, existing methods only run once when the earphones are first worn and active noise cancellation is activated to determine the current wearing state and select the corresponding parameters for the adaptive filter. If the wearing position of the earphones is adjusted afterward, the parameters of the adaptive filter cannot be updated in real time, leading to a degradation in noise cancellation performance.

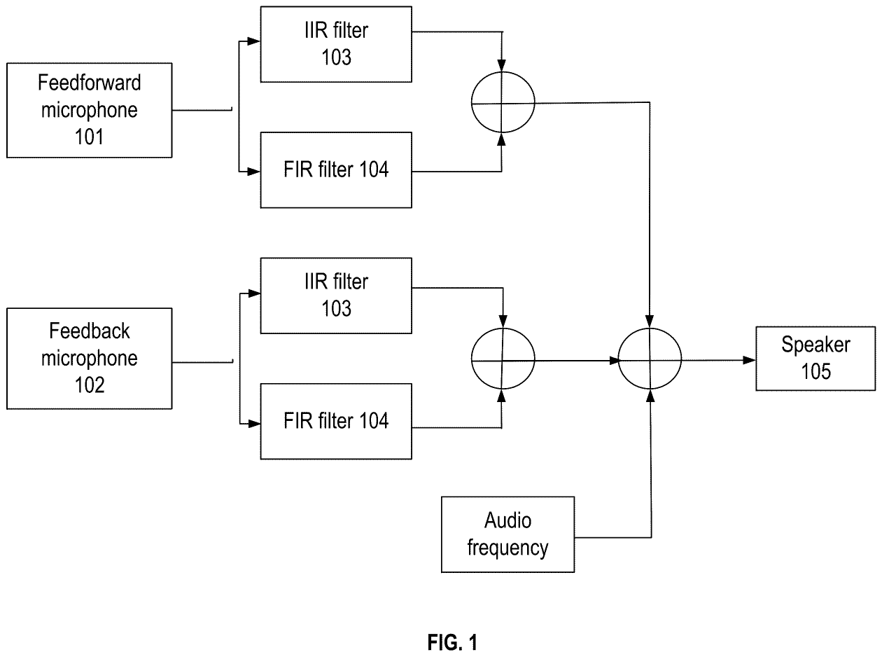

In some implementations of the present application, a method for real-time adaptive active noise cancellation is provided, which is used in active noise cancellation headphones. As shown in FIG. 1, the active noise cancellation headphones include a feedforward microphone 101, a feedback microphone 102, a speaker 105, and a filter, where the filter includes an IIR filter 103 and an FIR filter 104. It is noted that the headphones or earphones described herein, are merely illustrative and do not constitute a limitation. It can be any wearable audio (output) device that is configured to deliver processed audio to a user. For example, it can also be circumaural headphones, supra-aural headphones, earbuds, bone conduction transducer, bone conduction transducer, audio eyewear, speaker-integrated eyeglasses, Augmented Reality (AR)/Virtual Reality (VR) headsets, etc.

In the audio processing path illustrated in FIG. 1, the feedforward microphone 101 and the feedback microphone 102 are used to capture external audio signals. The feedforward microphone 101 is typically used to capture ambient noise, while the feedback microphone 102 is primarily used to capture audio leaking from the speaker 105. The audio signals captured by the feedforward microphone 101 and the feedback microphone 102 are input into the IIR filter 103 and the FIR filter 104, respectively, for filtering processing. The filtered signals are then combined separately. The combined signals from the feedforward channel and the feedback channel are further merged and mixed with the audio signal before being played through the speaker 105. It is noted that this is provided merely as an exemplary illustration and does not constitute a limitation on the specific solution.

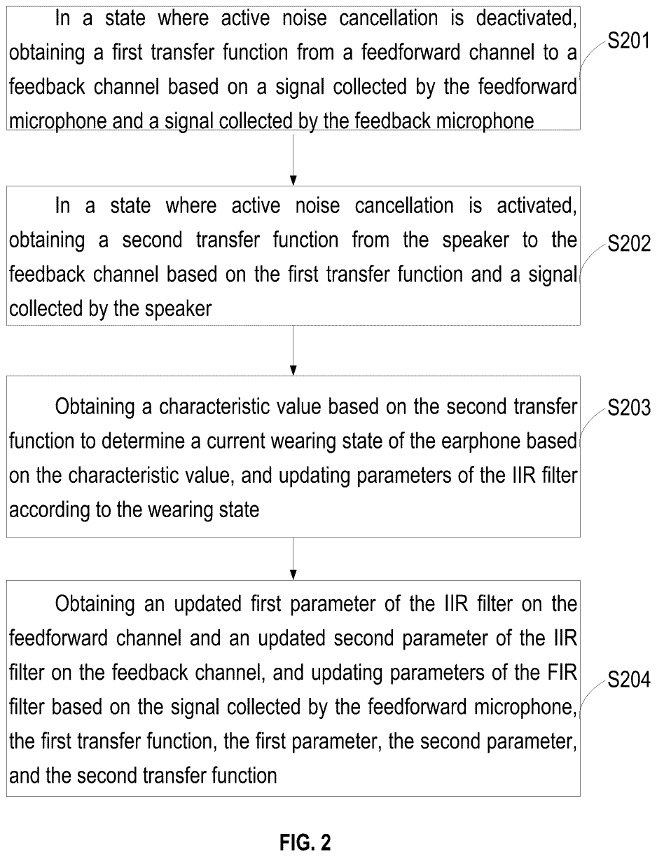

In some implementations, the method for real-time adaptive active noise cancellation is as shown in steps S201 to S204 of FIG. 2. The arrows indicating the sequence of steps in the diagram are merely illustrative and not restrictive. The technical solutions of the present application are not limited to the execution sequence described in the implementations. The steps in the execution sequence may be combined, split, or reordered, provided that the logical relationship of the execution content remains unaffected.

Headphones with active noise cancellation functionality may have several different noise cancellation modes, such as light noise cancellation mode, moderate noise cancellation mode, deep noise cancellation mode, or other modes, which are not limited herein.

In some implementations, several fixed sets of parameters can be configured for the IIR filter of the headphones, with each set corresponding to a different noise cancellation mode. For example, parameters of the adaptive IIR filter that achieve better noise cancellation effects under different wearing states of the headphones can be obtained using the feedforward microphone, feedback microphone, and speaker. These parameters can be written into the headphone's Flash memory to pre-configure preset sets of parameters for the IIR filter. Each preset set of parameters is used for noise cancellation processing when the headphones are in different wearing states.

In some implementations, the parameters may be frequency response parameters. During the configuration of the preset parameter sets, adjustments can be made based on the different wearing states of the headphones. For instance, when the headphones are worn loosely, snugly against the ears, or in other wearing states, corresponding parameter sets are defined. Each preset parameter set is also used to perform noise cancellation to varying degrees depending on the wearing state of the headphones.

In this implementation, each preset parameter set can also indicate the noise cancellation mode of the IIR filter when the headphones are in different wearing states.

In this implementation, when the headphones are powered on and active noise cancellation is turned off, signals from the feedforward microphone, feedback microphone, and speaker are simultaneously collected to detect the wearing state of the headphones. That is, when the headphones are powered on, algorithm initialization is performed while simultaneously collecting the speech signals from the feedforward microphone, the speech signals from the feedback microphone, and the playback signals from the speaker in real time. These three types of signals are converted into the frequency domain via Fast Fourier Transform (FFT) operations.

Based on the collected signals, the tightness of the headphone fit is detected. According to the detected wearing state, the parameters of the IIR filter are set to a preset parameter set matching the current wearing state of the headphones (as initial parameters), meaning the noise cancellation mode matching the current wearing state of the headphones is set as the initial noise cancellation mode.

In other words, when active noise cancellation is activated, the parameters of the IIR filter are set to one of the preset parameter sets as initial parameters based on the wearing state of the headphones. This allows for determining the current wearing state of the headphones based on the characteristic value and updating the initial parameters of the IIR filter according to the current wearing state.

In this implementation, in step S201, while active noise cancellation is turned off, a first transfer function from the feedforward channel to the feedback channel is obtained based on the signals collected by the feedforward microphone and the feedback microphone.

When the active noise cancellation function of the headphones is not enabled, it indicates that the active noise cancellation function is not operational, thereby avoiding interference from additional signal processing introduced by the active noise cancellation algorithm. Here, the feedforward channel can be understood as the transmission path of the signals collected by the feedforward microphone, while the feedback channel is the transmission path of the signals collected by the feedback microphone. By analyzing the signals collected by the feedforward microphone (input) and the feedback microphone (output) using signal processing methods such as Fourier transform, the transfer function from the feedforward channel to the feedback channel can be obtained. This transfer function reflects how the signals at the feedforward microphone end affect the signals at the feedback microphone end.

For example, the first transfer function from the feedforward channel to the feedback channel is P(z)=FB(z)/FF(z), where FB(z) represents the frequency-domain signal of the feedback microphone, and FF(z) represents the frequency-domain signal of the feedforward microphone.

In step S201, with active noise cancellation activated, a second transfer function from the speaker to the feedback channel is obtained based on the first transfer function and a signal collected by the speaker. In some implementations, when active noise cancellation is enabled, a preliminary determination of the wearing state of the earphone is made based on sound signals collected by the feedforward microphone, the feedback microphone, and the speaker. According to the current wearing state of the earphone, the parameters of the IIR filter are set to initial parameters, and the current noise cancellation mode of the earphone is the initial noise cancellation mode.

Herein, the current wearing state of the earphone may be preliminarily determined based on the leakage amount of noise. For example, when the leakage amount of noise falls within a first threshold range, the current wearing state of the earphone is a first state; when the leakage amount falls within a second threshold range, the current wearing state is a second state; and when the leakage amount falls within a third threshold range, the current wearing state is a third state.

This is provided merely as an exemplary illustration and does not limit the specific solution.

After the active noise cancellation function is activated, the system generates an anti-phase compensation signal through an algorithm based on signals collected by the feedforward microphone and the feedback microphone. This compensation signal is played by the speaker to cancel out ambient noise. At this time, the signal collected by the feedback microphone includes not only the original signal from the feedforward channel but also the compensation signal played by the speaker and the result of their interaction.

In the active noise cancellation state, the signal emitted by the speaker is a compensation signal generated for noise cancellation. Collecting the signal of the speaker allows understanding of the output produced by the system to cancel noise. By analyzing this signal and its relationship with the feedback microphone signal, the impact of the speaker signal on the feedback channel can be determined.

In some implementations, the second transfer function is S(z)=[FB(z)−FF(z)×P(z)]/SPK(z), where SPK(z) represents the frequency-domain signal of the speaker. Thus, this second transfer function describes how the signal emitted by the speaker affects the signal collected by the feedback channel in the active noise cancellation state.

In step S203, a characteristic value is obtained based on the second transfer function, to determine the current wearing state of the earphone based on the characteristic value, and update the parameters of the IIR filter according to the current wearing state.

In some implementations, some statistical features of the frequency response, such as mean, variance, and standard deviation, may be calculated based on the second transfer function. For example, calculating the average value of the frequency response amplitude within a certain frequency range can yield the average gain or attenuation of the system for signals in that frequency band. This average value may serve as the characteristic value.

In some implementations, frequency response analysis may be performed on the second transfer function to determine a peak value as the characteristic value. This is provided merely as an exemplary illustration and does not limit the specific definition of the characteristic value.

In this implementation, determining the current wearing state of the earphone based on the characteristic value may include judging the current wearing state of the earphone by comparing the characteristic value with a threshold.

For example, when the difference between the characteristic value and the threshold falls within a first preset range, the current wearing state of the earphone is the first state; when the difference falls within a second preset range, the current wearing state is the second state; and when the difference falls within a third preset range, the current wearing state is the third state. This is provided merely as an exemplary illustration and does not limit the specific solution.

That is, the current wearing state of the earphone may be determined based on the characteristic value, and the parameters of the IIR filter may be updated according to the updated current wearing state.

For example, after active noise cancellation is activated, the parameters of the IIR filter are initial parameters (assuming the initial parameters correspond to the first wearing state of the earphone). However, if the characteristic value indicates that the current wearing state of the earphone is the second state, the parameters of the IIR filter are updated according to the updated current wearing state.

In step S204, updated first parameters of the IIR filter on the feedforward channel and updated second parameters of the IIR filter on the feedback channel are acquired. Based on the signal collected by the feedforward microphone, the first transfer function, the first parameters, the second parameters, and the second transfer function, the parameters of the FIR filter are updated.

For example, by processing the signal collected by the feedforward microphone through the feedforward channel IIR filter (whose filtering characteristics are determined by the first parameters), combined with the signal relationship between channels described by the first transfer function and the second transfer function, as well as the effect of the feedback channel IIR filter (whose filtering characteristics are determined by the second parameters), how to update the parameters of the FIR filter may be determined to achieve better noise cancellation effect or more accurate audio signal restoration. This process may be iterative: as new input signals continuously arrive, the parameters of the IIR filter and the FIR filter are continuously updated and optimized to adapt to the changing signal environment, thereby ensuring good noise cancellation effect regardless of the earphone's position.

The method provided in this implementation of the application updates the IIR filter parameters in real time and simultaneously updates the FIR filter parameters, thereby adjusting the ANC state in real time and achieving good noise cancellation effect for different wearing positions. This means that any movement during the user's wearing of the earphone (such as head movement or loosening of the earphone) can trigger real-time adjustments of the IIR filter parameters and FIR filter parameters to ensure optimal noise cancellation effect.

In some implementations, the parameters of the FIR filter may be updated according to formula (1):

$$F B ( z ) = \frac{F F ( z ) * P ( z ) - F F ( z ) * ( {IIR}_{F F} + W ) * S ( z )}{1 + {IIR}_{F B} * S ( z )} = error \qquad formula ( 1 )$$

In formula (1), FB(z) represents the frequency-domain signal of the feedback microphone, FF(z) represents the frequency-domain signal of the feedforward microphone, P(z) represents the first transfer function, IIR_{FF} represents the updated first parameter of the IIR filter on the feedforward channel, IIR_{FB} represents the updated second parameter of the IIR filter on the feedback channel, S(z) represents the second transfer function, and W represents the parameter of the FIR filter, where the error is related to FB(z).

That is, the frequency signal FB(z) of the feedback microphone is used as the error for gradient descent updating to adjust the parameters of the FIR filter. The parameters of the FIR filter corresponding to when the error is less than a threshold are the updated parameters of the FIR filter; i.e., the updating stops when the error is less than the threshold. At this time, the earphone is in a stable state, and it can be considered that the updating of the FIR filter parameters is completed.

In some implementations, the FIR filter parameters may be optimized through the Least Mean Square (LMS) algorithm. The goal of the LMS algorithm is to minimize the expected value of the squared error, which is achieved through the gradient descent method—i.e., updating along the negative gradient direction of the squared error with respect to the FIR filter parameter W, gradually approaching the minimum value of the squared error, as shown in formula (2):

$$\frac{\partial error \hat{} 2}{\partial W} = \frac{\partial FB ( z ) \hat{} 2}{\partial W} = \frac{- 2 * F B ( z ) * F F ( z ) * S ( z )}{1 + {IIR}_{F B} * S ( Z )} = - 2 * FB ( z ) * {FF}^{′} \qquad formula ( 2 )$$

$$In formula ( 2 ) , {FF}^{′} = \frac{F F ( z ) * S ( z )}{1 + {IIR}_{F B} * S ( Z )}$$

And formula (1) is updated according to formula (3):

$$W ( n + 1 ) = W ( n ) + μ * F B ( z ) * {FF}^{′} \qquad formula ( 3 )$$

In formula (3), n represents the current time, n+1 represents the next time after the current time, and μ represents the update step size, which controls the magnitude of each update. If the value of μ is too large, parameter updates may overshoot the optimal value, preventing the algorithm from converging. If the value of μ is too small, the parameter update speed will be very slow, and the time for the algorithm to converge to the optimal value will be very long. W(n) is the FIR filter parameter at the current time, and W(n+1) is the updated FIR filter parameter at the next time.

Through the LMS algorithm, the parameters W of the FIR filter are continuously adjusted using the gradient descent method to minimize the expected value of the squared error. In some implementations, the partial derivative of the squared error with respect to the coefficient is calculated according to formula (2) to determine the update direction. Then, according to formula (3), the FIR filter parameters are updated in combination with the update step size u. Over time, the FIR filter parameters gradually converge to the optimal value, thereby optimizing the performance of the FIR filter.

Based on the audio signals collected by the feedforward microphone, the feedback microphone, and the speaker, S(z) is calculated in real time, and the noise cancellation mode of the IIR filter and the state of the FIR filter are updated.

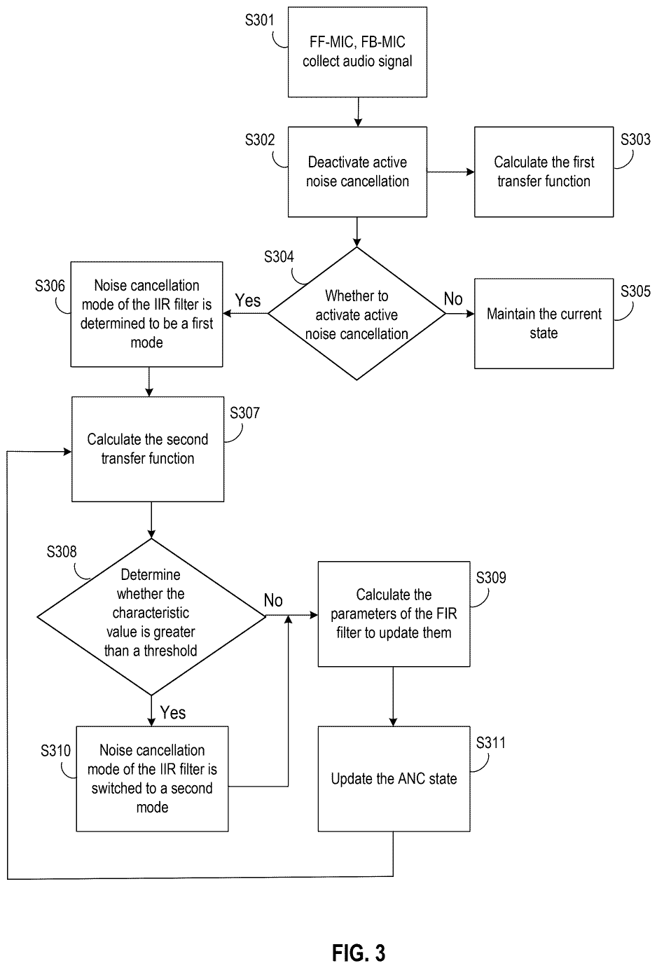

For example, as shown in FIG. 3, in step S301, the feedforward microphone (FF-MIC) and the feedback microphone (FB-MIC) collect sound. In step S302, active noise cancellation is turned off. Then, step S303 is executed to calculate the first transfer function. Concurrently, step S304 is executed to determine whether to enable active noise cancellation. If the determination result is negative, step S305 is executed to maintain the current state, i.e., no update is performed on the filter parameters. If the determination result is positive, the process continues to step S306, where the current wearing state of the earphone is detected based on the sound collected by the FF-MIC and FB-MIC. According to the detection result, the current wearing state of the earphone is determined, and based on the newly determined wearing state, the noise cancellation mode of the IIR filter is determined to be a first mode. The process then continues to step S307 to calculate the second transfer function and determine a characteristic value based thereon, subsequently proceeding to determine whether the characteristic value is greater than a threshold (as in step S308).

If the determination result in step S308 is negative, it indicates that the current wearing state of the earphone is similar to the wearing state detected when the earphone was started, with no significant positional change. At this time, there is no need to update the IIR filter parameters. The process continues to step S309 to calculate the parameters of the FIR filter to update them, thereby updating the ANC state (step S311).

Certainly, if the determination result in step S308 is positive, it indicates that the current wearing state of the earphone has changed compared to the initial state. The process then continues to step S310, where, based on the latest determined wearing state of the earphone, the noise cancellation mode of the IIR filter is switched to a second mode. Then, step S309 is executed.

That is, the signals from the feedforward microphone, the feedback microphone, and the speaker are continuously collected to persistently monitor changes in the frequency-domain signals of the feedforward microphone, the feedback microphone, and the speaker. The parameters of the IIR filter and the FIR filter are updated based on the changes in the frequency-domain signals. This real-time adaptive adjustment ensures that during the user's wearing of the earphone, regardless of any movement or change in the earphone's position, good noise cancellation effect is consistently maintained.

In some other implementations of the present application, an adaptive active noise cancellation earphone is provided, including a processor, a feedforward microphone, a feedback microphone, a speaker, and a filter, where the filter includes an IIR filter and an FIR filter. The processor is configured to: in a state where active noise cancellation is deactivated, obtain a first transfer function from the feedforward channel to the feedback channel based on a signal collected by the feedforward microphone and a signal collected by the feedback microphone; in a state where active noise cancellation is activated, obtain a second transfer function from the speaker to the feedback channel based on the first transfer function and a signal collected by the speaker; obtain a characteristic value based on the second transfer function to determine a current wearing state of the earphone based on the characteristic value, and update parameters of the IIR filter according to the current wearing state; and obtain an updated first parameter of the IIR filter on the feedforward channel and an updated second parameter of the IIR filter on the feedback channel, and update parameters of the FIR filter based on the signal collected by the feedforward microphone, the first transfer function, the first parameter, the second parameter, and the second transfer function.

Thus, by continuously monitoring data changes from the feedforward microphone, feedback microphone, and speaker, the parameters of the IIR filter and the FIR filter can be updated in real time. Any positional change of the earphone during user wear can trigger real-time adjustment of the ANC state, ensuring consistently effective noise cancellation performance throughout the wearing process.

In some other implementations of the present application, the processor is further configured to: continuously collect signals from the feedforward microphone, the feedback microphone, and the speaker to persistently monitor changes in the frequency-domain signals of the feedforward microphone, the feedback microphone, and the speaker, and update the parameters of the IIR filter and the FIR filter based on the changes in the frequency-domain signals.

The adaptive active noise cancellation earphone provided in this implementation enhances the noise cancellation effect by updating the parameters of the FIR filter in parallel based on the updated parameters of the IIR filter. The IIR filter is responsible for providing a fundamental noise cancellation frequency response curve, while the updating of the FIR filter parameters is used to further optimize the noise cancellation performance, ensuring that the earphone maintains excellent noise cancellation effect across various wearing states.

The processor may be a processing device including one or more general-purpose processing devices, such as a microprocessor, a Central Processing Unit (CPU), a Graphics Processing Unit (GPU), or the like. More specifically, the processor may be a Complex Instruction Set Computing (CISC) microprocessor, a Reduced Instruction Set Computing (RISC) microprocessor, a Very Long Instruction Word (VLIW) microprocessor, a processor executing other instruction sets, or a processor executing a combination of instruction sets. The processor may also be one or more dedicated processing devices, such as an Application-Specific Integrated Circuit (ASIC), a Field-Programmable Gate Array (FPGA), a Digital Signal Processor (DSP), a System on a Chip (SoC), or the like.

An implementation according to the present application further provides a computer-readable storage medium. The computer-readable storage medium stores computer instructions configured to cause a computer to execute the steps of the real-time adaptive active noise cancellation method as described in various implementations of the present application.

The aforementioned computer-readable storage medium may be, for example, Read-Only Memory (ROM), Random Access Memory (RAM), Phase-Change Random Access Memory (PRAM), Static Random Access Memory (SRAM), Dynamic Random Access Memory (DRAM), Electrically Erasable Programmable Read-Only Memory (EEPROM), other types of RAM, a flash drive or other forms of flash memory, cache, registers, static memory, Compact Disc Read-Only Memory (CD-ROM), Digital Versatile Disc (DVD) or other optical storage, magnetic cassettes or other magnetic storage devices, or any other possible non-transitory medium that can be used to store information or instructions accessible by a computer device.

An implementation according to the present application further provides a computer program product. The computer program product includes computer instructions configured to cause a computer to execute the steps in the real-time adaptive active noise cancellation method as described in various implementations of the present application.

The present application describes various operations or functions which may be implemented as software code or instructions or defined as software code or instructions. Such content may be source code or differential code (“delta” or “patch” code) in a directly executable (“object” or “executable” form). Software code or instructions may be stored in a computer-readable storage medium and, when executed, may cause a machine to perform the described functions or operations, and include any mechanism for storing information in a form accessible by a machine (e.g., computing device, electronic system, etc.), such as recordable or non-recordable media (e.g., Read-Only Memory (ROM), Random Access Memory (RAM), magnetic disk storage media, optical storage media, flash memory devices, etc.).

Furthermore, although exemplary implementations have been described herein, the scope includes any and all implementations based on the present application having equivalent elements, modifications, omissions, combinations (e.g., combinations of aspects from various implementations), adaptations, or alterations. The elements in the claims are to be interpreted broadly based on the language employed in the claims and not limited to the examples described in this specification or during the implementation of the present application, which examples are to be interpreted as non-exclusive. Therefore, this specification and the examples are intended to be considered merely exemplary, with the true scope and spirit being indicated by the following claims and the full range of equivalents thereof.

The above description is intended to be illustrative rather than restrictive. For example, the above examples (or one or more aspects thereof) may be used in combination with each other. Other implementations may be used by those of ordinary skill in the art upon reading the foregoing description. Additionally, in the above detailed description, various features may be grouped together to streamline the present application. This is not to be interpreted as an intention that any claimed feature not explicitly disclosed is essential to any claim. Rather, the subject matter of the present application may be defined by less than all features of a particular disclosed implementation. Thus, the claims are hereby incorporated into the detailed description as examples or implementations, wherein each claim stands on its own as a separate implementation, and it is contemplated that these implementations may be combined with each other in various combinations or permutations. The scope of the present application should be determined with reference to the appended claims, along with the full scope of equivalents to which such claims are entitled.

The above implementations are merely exemplary implementations of the present application and are not intended to limit the present application. The scope of protection of the present application is defined by the claims. Those skilled in the art may make various modifications or equivalent replacements to the present application within the essence and protection scope of the present application. Such modifications or equivalent replacements should also be considered as falling within the protection scope of the present application.

What is claimed is:

1. A real-time adaptive active noise cancellation method, performed by an earphone, wherein the earphone comprises: a feedforward microphone; a feedback microphone; a speaker; and a filter, and the filter comprises an Infinite Impulse Response (IIR) filter and a Finite Impulse Response (FIR) filter, wherein the method comprises:
in a state where active noise cancellation is deactivated, obtaining a first transfer function from a feedforward channel to a feedback channel based on a signal collected by the feedforward microphone and a signal collected by the feedback microphone;
in a state where active noise cancellation is activated, obtaining a second transfer function from the speaker to the feedback channel based on the first transfer function and a signal collected by the speaker;
obtaining a characteristic value based on the second transfer function to determine a current wearing state of the earphone based on the characteristic value, and updating parameters of the IIR filter according to the current wearing state; and
obtaining an updated first parameter of the IIR filter on the feedforward channel and an updated second parameter of the IIR filter on the feedback channel, and updating parameters of the FIR filter based on the signal collected by the feedforward microphone, the first transfer function, the first parameter, the second parameter, and the second transfer function.

2. The method according to claim 1, wherein updating the parameters of the FIR filter further comprises:
using a frequency signal of the feedback microphone as an error for gradient descent updating to adjust the parameters of the FIR filter, wherein the parameters of the FIR filter corresponding to when the error is less than a threshold are the updated parameters of the FIR filter.

3. The method according to claim 1, further comprising:
continuously collecting signals from the feedforward microphone, the feedback microphone, and the speaker to monitor changes in frequency-domain signals of the feedforward microphone, the feedback microphone, and the speaker, and updating the parameters of the IIR filter and the FIR filter based on the changes in the frequency-domain signals.

4. The method according to claim 1, further comprising:
pre-configuring the IIR filter with preset sets of parameters, wherein each of the preset sets of parameters is used for noise cancellation processing of the earphone in different wearing states;
in a state where the earphone is powered on and active noise cancellation is deactivated, simultaneously collecting signals from the feedforward microphone, the feedback microphone, and the speaker to detect the current wearing state of the earphone; and
in a state where active noise cancellation is activated, setting the parameters of the IIR filter to one of the preset sets of parameters as an initial set of parameters based on the current wearing state of the earphone, so as to determine the current wearing state of the earphone based on the characteristic value and update the initial set of parameters of the IIR filter according to the current wearing state.

5. The method according to claim 1, wherein the parameters of the FIR filter are updated according to a formula (1):
$$F B ( z ) = \frac{F F ( z ) * P ( z ) - F F ( z ) * ( {IIR}_{F F} + W ) * S ( z )}{1 + {IIR}_{F B} * S ( z )} = error ,$$
wherein in the formula (1), FB(z) represents a frequency-domain signal of the feedback microphone, FF(z) represents a frequency-domain signal of the feedforward microphone, P(z) represents the first transfer function, IIRFF represents the updated first parameter of the IIR filter on the feedforward channel, IIRFB represents the updated second parameter of the IIR filter on the feedback channel, S(z) represents the second transfer function, and W represents the parameters of the FIR filter.

6. The method according to claim 5, wherein the parameters of the FIR filter are optimized according to a formula (2):
$$\frac{\partial {error}^{2}}{\partial W} = \frac{\partial F {B ( z )}^{2}}{\partial W} = \frac{- 2 * FB ( z ) * F F ( z ) * S ( z )}{1 + {IIR}_{F B} * S ( Z )} = - 2 * FB ( z ) * {FF}^{′} ;$$
wherein in the formula (2),
$${FF}^{′} = \frac{F F ( z ) * S ( z )}{1 + {IIR}_{F B} * S ( Z )} ;$$
wherein the formula (1) is updated according to a formula (3):
W(n+1)=W(n)+μ*FB(z)*FF′; and
wherein in the formula (3), n represents a current time, n+1 represents a next time after the current time, and μ represents an update step size.

7. An adaptive active noise cancellation earphone, comprising:
a processor;
a feedforward microphone;
a feedback microphone;
a speaker; and
a filter, wherein the filter comprises an Infinite Impulse Response (IIR) filter and a Finite Impulse Response (FIR) filter, and the processor is configured to:
in a state where active noise cancellation is deactivated, obtain a first transfer function from a feedforward channel to a feedback channel based on a signal collected by the feedforward microphone and a signal collected by the feedback microphone;
in a state where active noise cancellation is activated, obtain a second transfer function from the speaker to the feedback channel based on the first transfer function and a signal collected by the speaker;
obtain a characteristic value based on the second transfer function to determine a current wearing state of the earphone based on the characteristic value, and update parameters of the IIR filter according to the current wearing state; and
obtain an updated first parameter of the IIR filter on the feedforward channel and an updated second parameter of the IIR filter on the feedback channel, and update parameters of the FIR filter based on the signal collected by the feedforward microphone, the first transfer function, the first parameter, the second parameter, and the second transfer function.

8. The adaptive active noise cancellation earphone according to claim 7, wherein the processor is configured to update the parameters of the FIR filter further configured to:
use a frequency signal of the feedback microphone as an error for gradient descent updating to adjust the parameters of the FIR filter, wherein the parameters of the FIR filter corresponding to when the error is less than a threshold are the updated parameters of the FIR filter.

9. The adaptive active noise cancellation earphone according to claim 7, wherein the processor is further configured to:
continuously collect signals from the feedforward microphone, the feedback microphone, and the speaker to monitor changes in frequency-domain signals of the feedforward microphone, the feedback microphone, and the speaker, and update the parameters of the IIR filter and the FIR filter based on the changes in the frequency-domain signals.

10. The adaptive active noise cancellation earphone according to claim 7, wherein the processor is further configured to:
pre-configure the IIR filter with preset sets of parameters, wherein each of the preset sets of parameters is used for noise cancellation processing of the earphone in different wearing states;
in a state where the earphone is powered on and active noise cancellation is deactivated, simultaneously collect signals from the feedforward microphone, the feedback microphone, and the speaker to detect the current wearing state of the earphone; and
in a state where active noise cancellation is activated, set the parameters of the IIR filter to one of the preset sets of parameters as an initial set of parameters based on the current wearing state of the earphone, so as to determine the current wearing state of the earphone based on the characteristic value and update the initial set of parameters of the IIR filter according to the current wearing state.

11. The adaptive active noise cancellation earphone according to claim 7, wherein the parameters of the FIR filter are updated according to a formula (1):
$$F B ( z ) = \frac{F F ( z ) * P ( z ) - F F ( z ) * ( {IIR}_{F F} + W ) * S ( z )}{1 + {IIR}_{F B} * S ( z )} = error ,$$
wherein in the formula (1), FB(z) represents a frequency-domain signal of the feedback microphone, FF(z) represents a frequency-domain signal of the feedforward microphone, P(z) represents the first transfer function, IIR_{FF} represents the updated first parameter of the IIR filter on the feedforward channel, IIR_{FB} represents the updated second parameter of the IIR filter on the feedback channel, S(z) represents the second transfer function, and W represents the parameters of the FIR filter.

12. The adaptive active noise cancellation earphone according to claim 11, wherein the parameters of the FIR filter are optimized according to a formula (2):
$$\frac{\partial {error}^{2}}{\partial W} = \frac{\partial F {B ( z )}^{2}}{\partial W} = \frac{- 2 * F B ( z ) * F F ( z ) * S ( z )}{1 + {IIR}_{F B} * S ( Z )} = - 2 * F B ( z ) * F {F}^{′} ;$$
wherein in the formula (2),
$$F {F}^{′} = \frac{F F ( z ) * S ( z )}{1 + {IIR}_{F B} * S ( Z )} ;$$
wherein the formula (1) is updated according to a formula (3):
W(n+1)=W(n)+μ*FB(z)*FF′; and
wherein in the formula (3), n represents a current time, n+1 represents a next time after the current time, and μ represents an update step size.

13. A non-transitory computer-readable storage medium storing instructions that, when executed by a processor of an earphone, cause the processor to perform operations comprising:
in a state where active noise cancellation is deactivated, obtaining a first transfer function from a feedforward channel to a feedback channel based on a signal collected by a feedforward microphone and a signal collected by a feedback microphone;
in a state where active noise cancellation is activated, obtaining a second transfer function from a speaker to the feedback channel based on the first transfer function and a signal collected by the speaker;
obtaining a characteristic value based on the second transfer function to determine a current wearing state of the earphone based on the characteristic value, and updating parameters of an Infinite Impulse Response (IIR) filter according to the current wearing state; and
obtaining an updated first parameter of the IIR filter on the feedforward channel and an updated second parameter of the IIR filter on the feedback channel, and updating parameters of a Finite Impulse Response (FIR) filter based on the signal collected by the feedforward microphone, the first transfer function, the first parameter, the second parameter, and the second transfer function.

14. The non-transitory computer-readable storage medium according to claim 13, wherein updating the parameters of the FIR filter further comprises:
using a frequency signal of the feedback microphone as an error for gradient descent updating to adjust the parameters of the FIR filter, wherein the parameters of the FIR filter corresponding to when the error is less than a threshold are the updated parameters of the FIR filter.

15. The non-transitory computer-readable storage medium according to claim 13, wherein the operations further comprise:
continuously collecting signals from the feedforward microphone, the feedback microphone, and the speaker to monitor changes in frequency-domain signals of the feedforward microphone, the feedback microphone, and the speaker, and updating the parameters of the IIR filter and the FIR filter based on the changes in the frequency-domain signals.

16. The non-transitory computer-readable storage medium according to claim 13, wherein the operations further comprise:
pre-configuring the IIR filter with preset sets of parameters, wherein each of the preset sets of parameters is used for noise cancellation processing of the earphone in different wearing states;
in a state where the earphone is powered on and active noise cancellation is deactivated, simultaneously collecting signals from the feedforward microphone, the feedback microphone, and the speaker to detect the current wearing state of the earphone; and
in a state where active noise cancellation is activated, setting the parameters of the IIR filter to one of the preset sets of parameters as an initial set of parameters based on the current wearing state of the earphone, so as to determine the current wearing state of the earphone based on the characteristic value and update the initial set of parameters of the IIR filter according to the current wearing state.

17. The non-transitory computer-readable storage medium according to claim 13, wherein the parameters of the FIR filter are updated according to a formula (1):
$$FB ( z ) = \frac{FF ( z ) * P ( z ) - F F ( z ) * ( {IIR}_{F F} + W ) * S ( z )}{1 + {IIR}_{F B} * S ( z )} = error ,$$
wherein in the formula (1), FB(z) represents a frequency-domain signal of the feedback microphone, FF(z) represents a frequency-domain signal of the feedforward microphone, P(z) represents the first transfer function, IIRFF represents the updated first parameter of the IIR filter on the feedforward channel, IIRFB represents the updated second parameter of the IIR filter on the feedback channel, S(z) represents the second transfer function, and W represents the parameters of the FIR filter.

18. The non-transitory computer-readable storage medium according to claim 17, wherein the parameters of the FIR filter are optimized according to a formula (2):
$$\frac{\partial {error}^{2}}{\partial W} = \frac{\partial F {B ( z )}^{2}}{\partial W} = \frac{- 2 * F B ( z ) * F F ( z ) * S ( z )}{1 + {IIR}_{F B} * S ( Z )} = - 2 * F B ( z ) * F {F}^{′} ;$$
wherein in the formula (2),
$$F {F}^{′} = \frac{F F ( z ) * S ( z )}{1 + {IIR}_{F B} * S ( Z )} ;$$
wherein the formula (1) is updated according to a formula (3):
W(n+1)=W(n)+μ*FB(z)*FF′; and
wherein in the formula (3), n represents a current time, n+1 represents a next time after the current time, and μ represents an update step size.
